(19) United States
(12) Patent Application Publication
(10) Pub. No.: US 2023/0404028 A1
(43) Pub. Date: Dec. 21, 2023

(54) FEED SILO

(71) Applicants: Katherine STINSON, Jefferson, OH (US); COOPWORX LLC, WILMINGTON, NC (US)

(72) Inventors: WALLACE THOMAS CARTER, WILMINGTON, NC (US); KATHERINE STINSON, JEFFERSON, OH (US)

(73) Assignee: COOPWORX LLC, WILMINGTON, NC (US)

(21) Appl. No.: 18/252,003

(22) PCT Filed: Nov. 5, 2021
(86) PCT No.: PCT/US21/58201

§ 371 Date: May 5, 2023

Related U.S. Application Data
(60) Provisional application No. 63/109,889, filed on Nov. 5, 2020.

(51) Int. Cl. A01K 5/02; A01K 7/02

(52) U.S. Cl. CPC A01K 5/0225; A01K 7/02

(57) ABSTRACT

A feed and water distribution device with a housing and a drip edge that hangs over protecting one or more feed ports or openings in the housing of the device. Each opening can be fitted with a plug that may also feature a shelf, wall and/or a drinking or watering valve. The housing of the device is shaped such that a portion of it covers the opening(s) in the housing through which feed and water can be obtained by animals. The housing can feature a drip edge. Optional plugs fit into the openings and can feature watering valves that can be manipulated by animals to dispense water. The interior cavity of the housing can be fitted with a funnel to direct the feed toward the center of the interior cavity. The floor of the housing can be cone shaped to help direct feed passing through the funnel towards each opening.

### CROSS-REFERENCE TO RELATED APPLICATIONS

This application claims the benefit of priority to U.S. Provisional Application No. 63/109,889 filed on Nov. 5, 2020. The content of U.S. Provisional Application No. 63/109,889 filed on Nov. 5, 2020 is incorporated by reference in its entirety.

This application claims the benefit of priority to PCT Application No. PCT/US21/58201 filed on Nov. 5, 2021. The content of PCT Application No. PCT/US21/58201 filed on Nov. 5, 2020 is incorporated by reference in its entirety.

### BACKGROUND OF THE INVENTION

### (a) Field of Invention

This disclosure relates to a novel apparatus and method of feeding and watering animals. More specifically, this disclosure relates to a device and method of feeding and watering backyard fowl, such as chickens.

### (b) Background Art

Chicken feeders that are currently on the market take one of a few different forms. The most basic form is a cylindrically shaped structure that holds feed and allows the feed to be guided downward by gravity. The bottom of the cylindrical housing has one or more openings through which feed spills into a tray that encircles the cylindrical housing. Because setting this structure on the ground can cause it to become wet, increases the exposure of the feed to insects and rodents and allows the chickens to waste feed by scratching it out of the device, the structure can be suspended or hung from a separate structure such as a portion of the chicken coop frame. This helps to keep the feed in the device dry and to prevent the birds from knocking the device over. Any chicken feeder must be difficult to knock over as chickens tend to explore their world by scratching and pecking and tend to knock things over in the process.

This basic design has several well-known drawbacks including, but not limited to, constant exposure of the feed to the elements. As a result, some improvements have been made in this field over the years. For example, a treadle chicken feeder is a feeding box that has a platform operably connected to a lid that covers the portion of the device that contains feed. When sufficient weight is applied to the platform, the lid opens and uncovers the reservoir of feed in the device, thereby allowing the birds to reach it. This device requires training for the birds to be able to use it and it allows the feed to become wet or exposed to insects and rodents when the lid is opened. In addition, there is nothing that prevents the feed from becoming contaminated when exposed to animal waste as the device necessarily has to be placed near the ground where the birds can step on it.

There are also a number of devices that are made of PVC (polyvinylchloride) or similar materials that are either tube or bucket shaped and feature and upturned spout to prevent feed from falling onto the ground. These devices are less sophisticated than the treadle chicken feeders and as a result are easier to make and maintain. However, they do not solve any of the problems presented by devices above. The feed is still exposed to the weather and is left open to insects and rodents.

There is a need in the industry for an improved feeder that (1) protects the feed from damage caused by the elements, (2) keeps the feeder off the ground, (3) keeps the feeder out of reach of rodents and insects (4) prevents the birds from scratching feed out of the feeder and (5) prevents the birds from defecating in the feed. This disclosure details a device and method using the device that solves these problems and provides other advantages over the prior art.

### BRIEF SUMMARY OF THE INVENTION

This disclosure relates to a novel feeder that is suitable for use with various types of domesticated fowl including chickens, ducks, turkeys and guinea hens. The feeder is shaped to prevent the feed from becoming contaminated by precipitation. Preferred embodiments of the feeder feature a body or housing which is larger in diameter than the feed area and has “drip edges” or surfaces on the body of the feeder that serve to cover or hang over the portion of the device from which animals feed. This shape allows the body of the device to cover the feed such that it does not get wet when it rains, for example. In addition, the body of the device is shaped to make it difficult for birds to roost on top of the device; thereby, making it difficult for their droppings to wind up in the feeder or the feed itself. Preferred embodiments of the feeder have a body with a lid that with a steep pitch that makes it difficult for birds to roost on the top of the device. The inventors' have found that a roof angle of approximately 30 degrees or more is optimal to prevent birds from roosting on the lid. In other words, the lid has an upper or outer surface that extends away from the body of the feeder at an angle of at least 30 degrees. That is to say the angle between the outer surface of the lid and a theoretical horizontal line drawn from one side to the other side of the opening in the body is at least 30 degrees. This angle corresponds to approximately a 7:12 pitch or a rise of approximately 7 inches of height for every 12 inches of depth. Approximately in this context means within 1 degree of the stated angle or 1 inch of the stated measurement.

Preferred embodiments of the feeder have a plurality of feed ports that are located on a lower portion or bottom of the body of the feeder. The lower portion of the body that features the feed ports is tapered, i.e. the upper section of the body has a larger diameter than the lower section in which the feed ports are located. This configuration takes advantage of the drip edges located on the upper section of the body of the device in that any precipitation that is falling onto the lid of the device will get directed by the shape of the lid and body of the device away from the feed ports.

The feed ports are openings that communicate with an interior cavity featured by the body or housing of the feeder. Each opening can optionally be fitted with a ring or plug. In preferred embodiments, the plug is shaped like a truncated cylinder, i.e., the wall(s) of the plug are not a uniform height. This lack of uniformity creates a hood that extends away from the feeder when the ring is positioned inside the feed port. The taller or longer section of the walls of the plug is positioned to partially cover the feed port. In addition, some embodiments feature a small wall that partially closes the opening of the cylinder. This wall also helps prevent feed from spilling out of the feeder, particularly when the feeder is being filled.

The interior of the feeder can be accessed by opening the hinged lid. There is a funnel that is located inside the body of the device. It is positioned above a cone that is located on a floor or bottom surface of the interior of the body of the feeder. The feed is loaded through the top of the body of the device after opening the lid. The feed immediately falls through the funnel that directs the feed toward the center of the floor of the body. Preferred embodiments also feature a cone onto which the feed falls as it is loaded into the feeder. The feed distribution cone is located on the floor of the interior of the body of the feeder and forces feed that is falling through the funnel away from the center of the feeder towards the feed ports. This prevents “dead spots” that the animals cannot get to when feeding.

Another embodiment of the disclosed silo feeder is adapted to hold water instead of feed. In this case, the feed ports are closed with a different type of plug that features a drinking valve or nipple that when manipulated by an animal, causes water to flow out of the interior cavity of the silo feeder and through the drinking valve featured by the plug.

The device can be supported in more than one way. Preferred embodiments of the feeder include a plurality of legs the height of which can be adjusted. In addition, the legs are removable. Some embodiments of the legs also feature a plate positioned over an opening or pocket into which the leg is inserted when attached to the feeder. The plate helps to prevent rodents from climbing up the legs into the feeder. In addition, the feed funnel can be equipped with molded female receptacles that fit and lock in place over molded sleeves used to attach the legs to the feeder.

In addition, a single post can be used to support the feeder. The exterior of the bottom of the body of the device is inverted where the feed distribution cone is located, i.e. the feed distribution cone extends upward into the interior of the feeder creating a divot or insertion point into which a single post can be inserted to support the device. This configuration also prevents rodents from climbing into the feeder using the post in that the post is connected to the underside of the feeder and does not communicate with the interior of the feeder.

The novel feeder that is herein described has a number of advantages over the prior art. The disclosed feeder protects the feed from moisture or precipitation as well as bird droppings, makes it easier for feed to be distributed to the feed ports, and makes it difficult for rodents to enter the device and steal or contaminate some of the feed. It is easy to load the feeder and distribute feed to the feed ports without spilling the feed out of the feed ports and the configuration of the interior of the device virtually eliminates portions of the interior where feed accumulates and does not leave the feeder.

### BRIEF DESCRIPTION OF THE DRAWINGS

FIG. 1 is a front plan view of a preferred embodiment of the silo feeder;

FIG. 2A is a front plan view of a preferred embodiment of the plug;

FIG. 2B is a side plan view of a preferred embodiment of the plug;

FIG. 2C is a rear plan view of a preferred embodiment of the plug;

FIG. 2D is a top plan view of a preferred embodiment of the plug;

FIG. 2E is a bottom plan view of a preferred embodiment of the plug;

FIG. 2F is a side perspective view of a preferred embodiment of the plug;

FIG. 3 is a perspective view of a preferred embodiment of the plug being inserted into a feed port; and

FIG. 4 is a perspective view of a cover being paced over a feed port;

FIG. 5 is a cross sectional view of the feeder with the lid open;

FIG. 6 is a top perspective view thereof;

FIG. 7A is a cross-sectional view of the feeder with the post inserted into the pocket on the underside of the feeder;

FIG. 7B is a bottom perspective view thereof;

FIG. 8 is a front perspective view of the feeder with a plurality of legs attached thereto;

FIG. 9 is a top perspective view of the funnel;

FIG. 10 is a side perspective view of another embodiment of the feeder;

FIG. 11 is a front perspective view of the plug featuring a water valve; and

FIG. 12 is a rear perspective view of the plug featuring a water valve.

### DESCRIPTION OF EMBODIMENTS

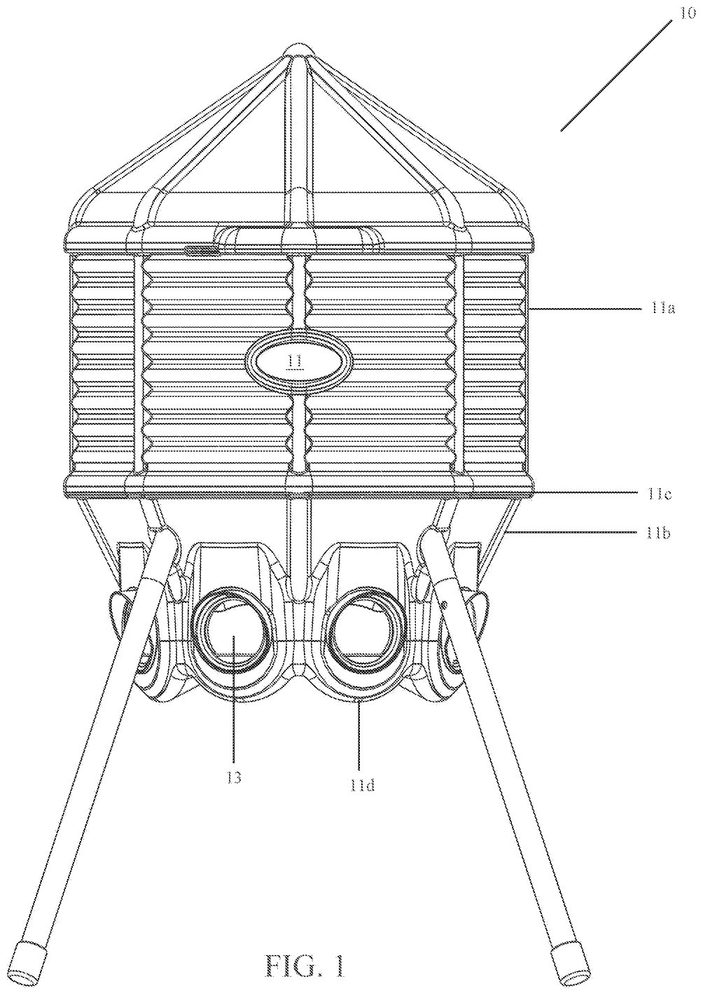

FIG. 1 shows a preferred embodiment of the silo feeder 10. The silo feeder 10 has a body or housing 11 with an upper section 11a and a lower section 11b that is tapered. Tapered in this sense means that there is a portion of the body 11 of the feeder 10 that is smaller in diameter than the rest of the body 11. The tapered section 11b features at least one feed port 13. The feed ports 13 are openings in the body 11 of the device 10 through which animals can access the feed that is loaded into the device 10. Because the tapered or lower section 11b of the body 11 of the silo feeder 10 is smaller in diameter than the upper section 11a, the upper section 11a provides protection from anything falling off or rolling off the upper section 11a of the body 11. In addition, preferred embodiments and the inventors' anticipated best mode of the feeder 10 include a drip edge 11c or a portion of the body 11. This drip edge 11c is simply a portion of the body 11 that protrudes away from the body 11 of the feeder 10 such that it prevents precipitation and anything else that is sliding along the surface of the feeder 10 from reaching the lower section 11b of the body 11 that features the feed ports 13. The drip edge 11c is positioned above the feed port(s) 13 to prevent precipitation from falling into the feed port(s) 13. The openings that comprise the feed ports 13 face or are oriented horizontally, i.e. oriented such that the opening is not facing upward or downward with respect to the rest of the feeder 10. Rather, the opening that constitutes the feed port 13 faces outward away from the body 11 of the feeder 10 to prevent anything from falling into the opening/feed port 13. By way of comparison, the opening to body 11 of the device 10 covered by the lid 11 is a vertically oriented opening in that it faces upward rather than sideways like the feed ports 13. In addition, preferred embodiments and the inventors' anticipated best mode of the feeder include rounded portions 11d of the body 11 under and just inside one or more of the feed ports 13. These rounded portions 11d of the body 11 allow feed to accumulate in an area where the animals can easily reach it.

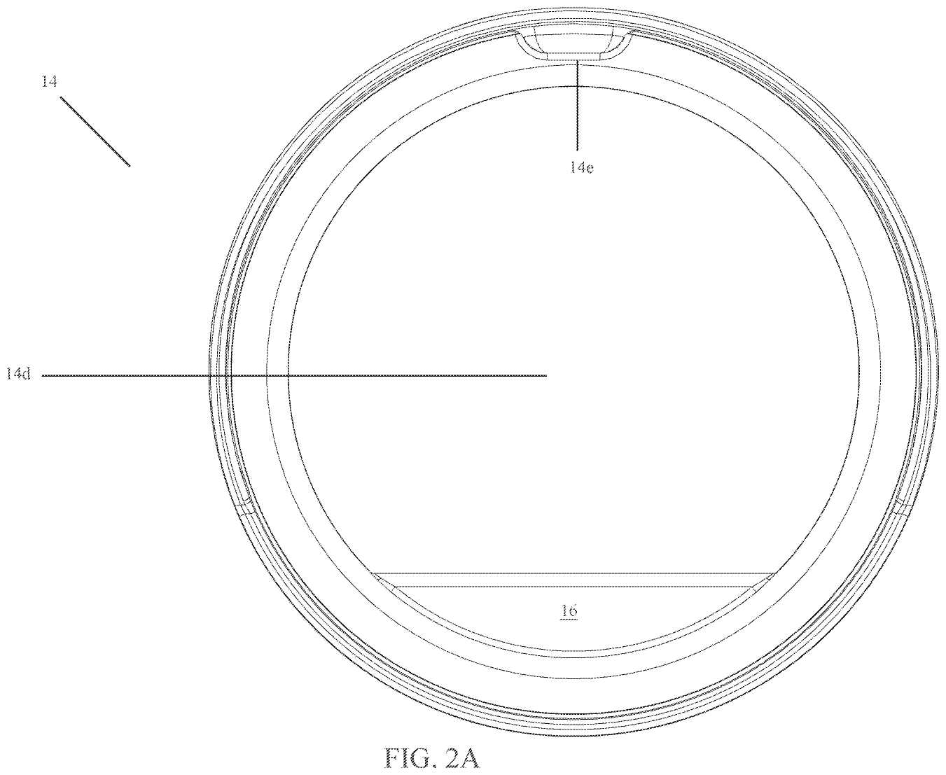

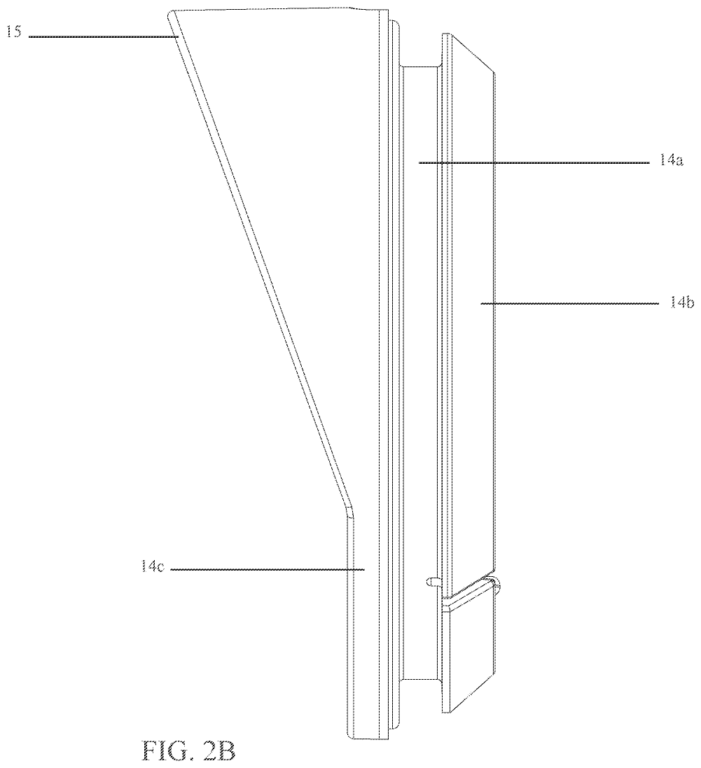

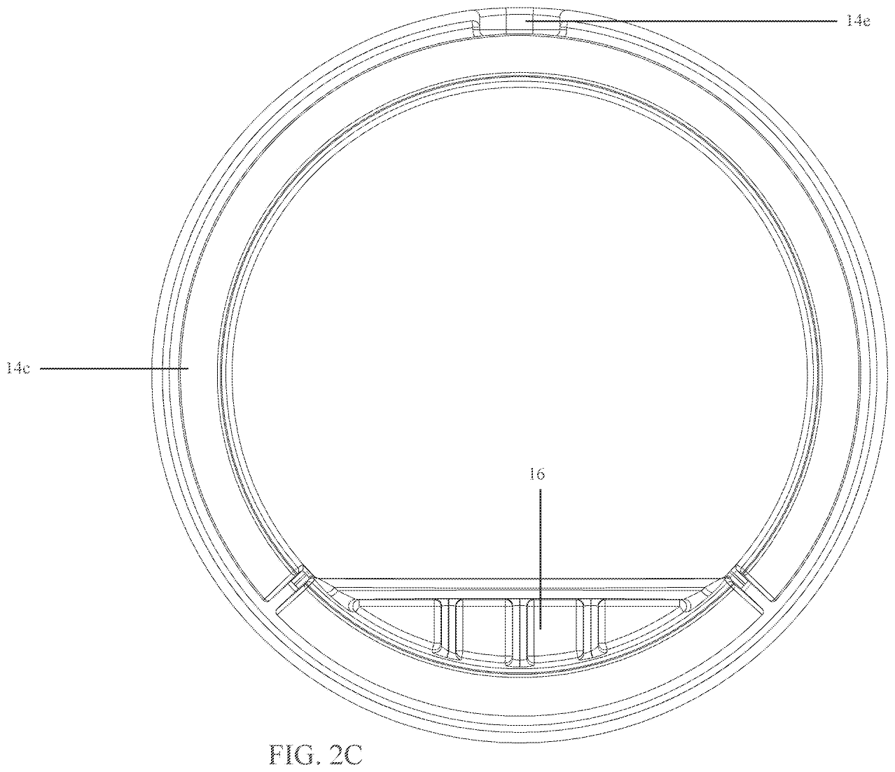

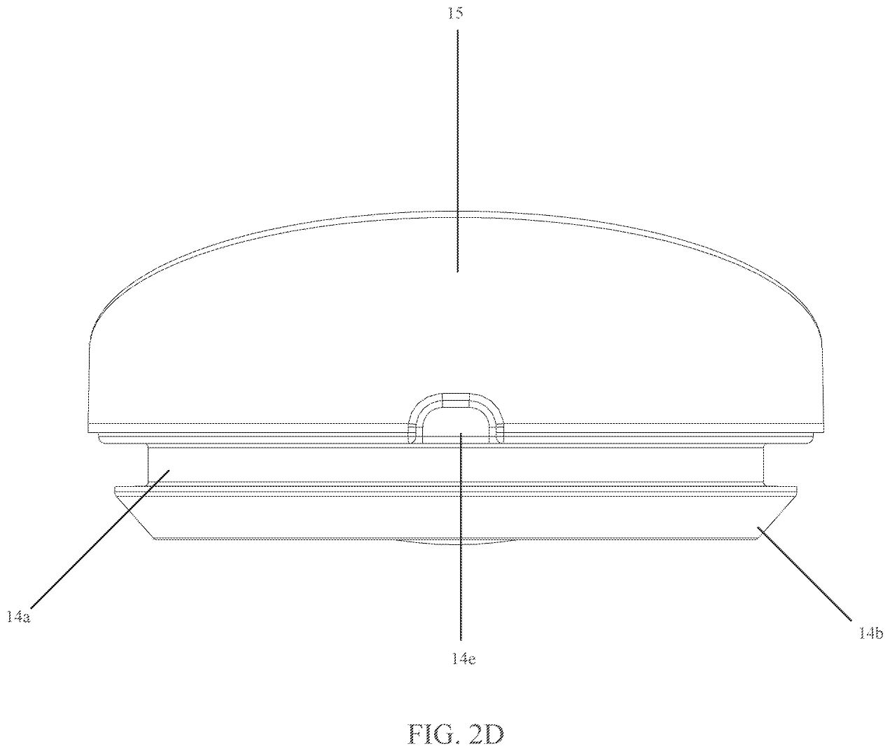

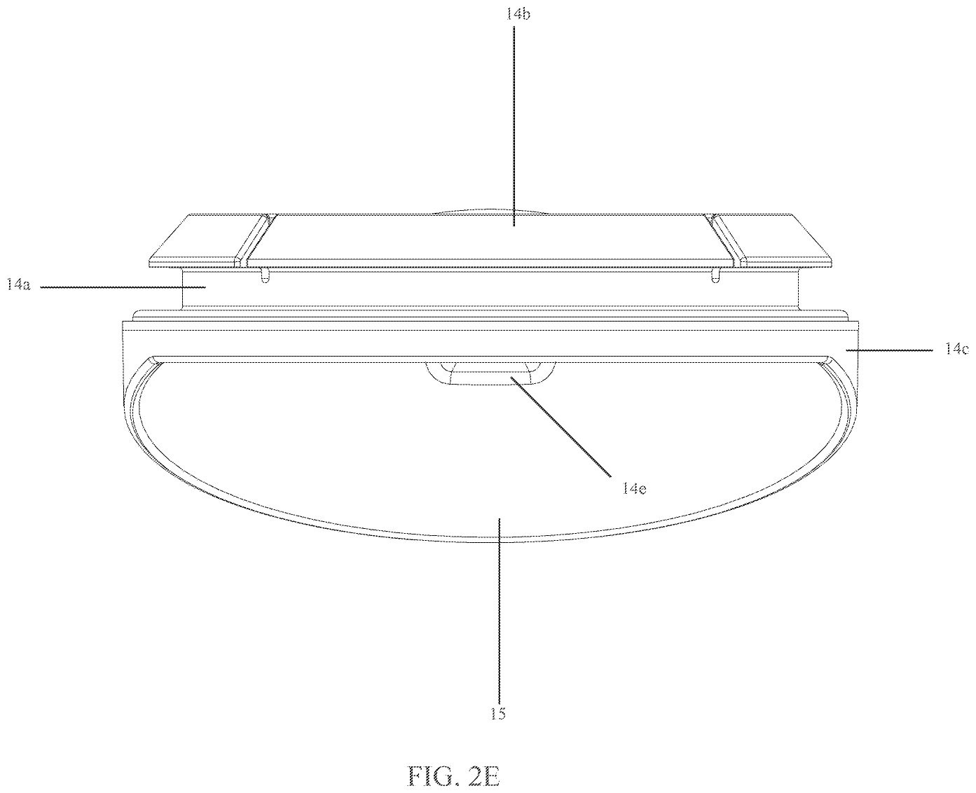

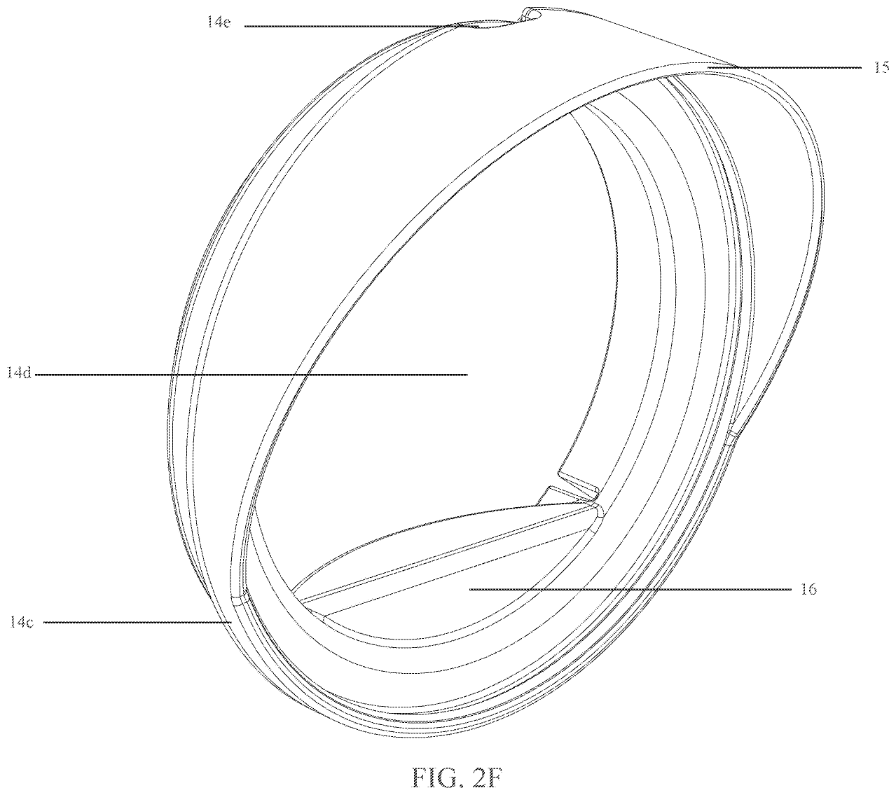

FIGS. 2A through 2F show an optional plug 14 that fits into a feed port 13. The plug 14 is an annular ring that is configured to be positioned inside the opening that is makes up each feed port 13. Preferred versions of the feed port plug 14 include a ring-like structure that is shaped like a truncated cylinder, i.e. a cylinder that has an uneven side wall 14c or height, that is open at both ends. The opening 14d in the plug communicates or leads to the interior cavity 12 of the housing or body 11. The plug 14 has an annular base 14b that connects to, inserts into and/or engages with the opening that constitutes the feed port 13. Preferred embodiments of the plug 14 feature a groove 14a that can snap into and engage with the edges of the body flanking the feed port 14.

As mentioned above, the side wall(s) of the cylindrically shaped plug are not uniform, i.e. a portion of the side wall 14c of the plug 14 can extend further away from the base 14b of the cylindrical plug 14 than other portions of the side wall 14c. This extended portion can form a hood 15 that extends away from the rest of the plug 14 and the feeder 10. This hood 15 provides additional coverage or shielding from any precipitation or bird droppings that could fall in or near the feed port 13. Other versions of the plug 14 include a vertically oriented wall 16 that covers a portion of the opening 14d in the plug 14 that communicates with the feed port 13. This wall 16 is small enough for the birds to peck feed around or over it, but at the same time reduces feed spillage when the bird is feeding and/or when feed is being loaded into the interior cavity 12 of the feeder as it prevents birds from scratching or dragging feed out of the feed port 13. Preferred embodiments of the device feature plugs or other portions of the device that are red as some backyard fowl such as chickens are said to be attracted to the color red.

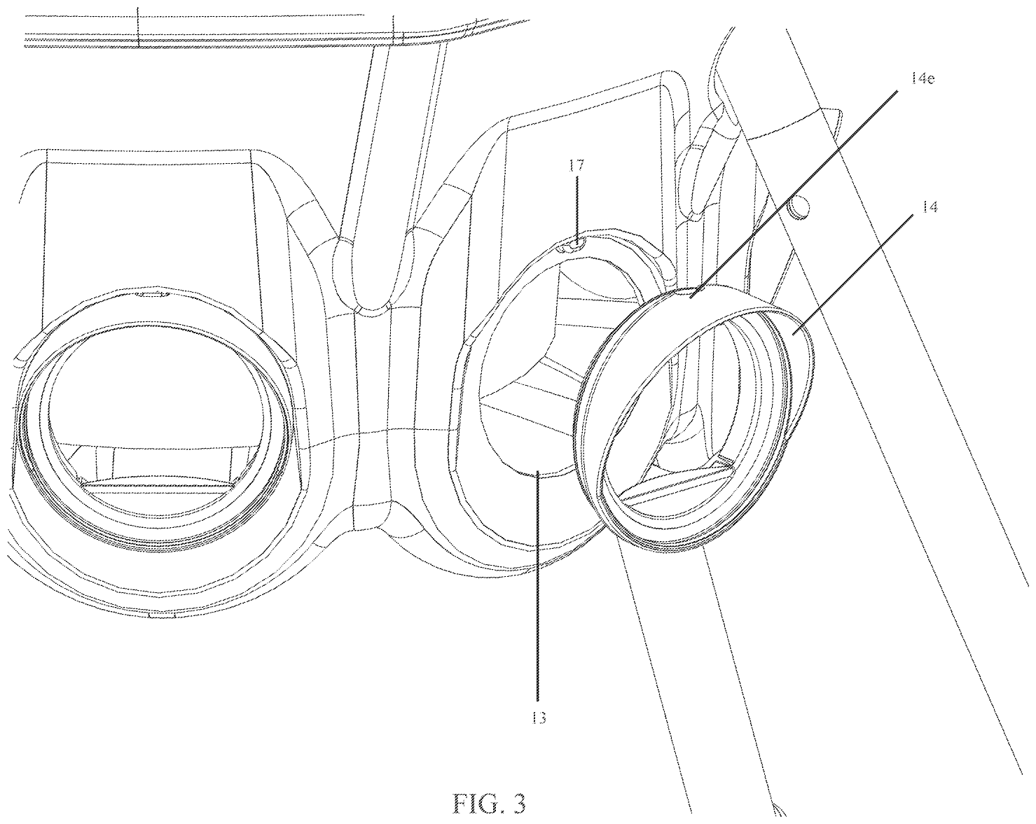

FIG. 3 shows the plug 14 being placed into the feed port 13. Preferred embodiments and the inventors' anticipated best mode of the device 10 include a protrusion 17 located along on a portion of the body 11 of the device 10 that flanks the opening that makes up a feed port 13. Further, these embodiments may have a notch 14e on an exterior of the plug 14 that engages with the protrusion 17 when the plug is inserted into the feed port 13. This helps prevent the plug 14 from rotating inside the feed port 13.

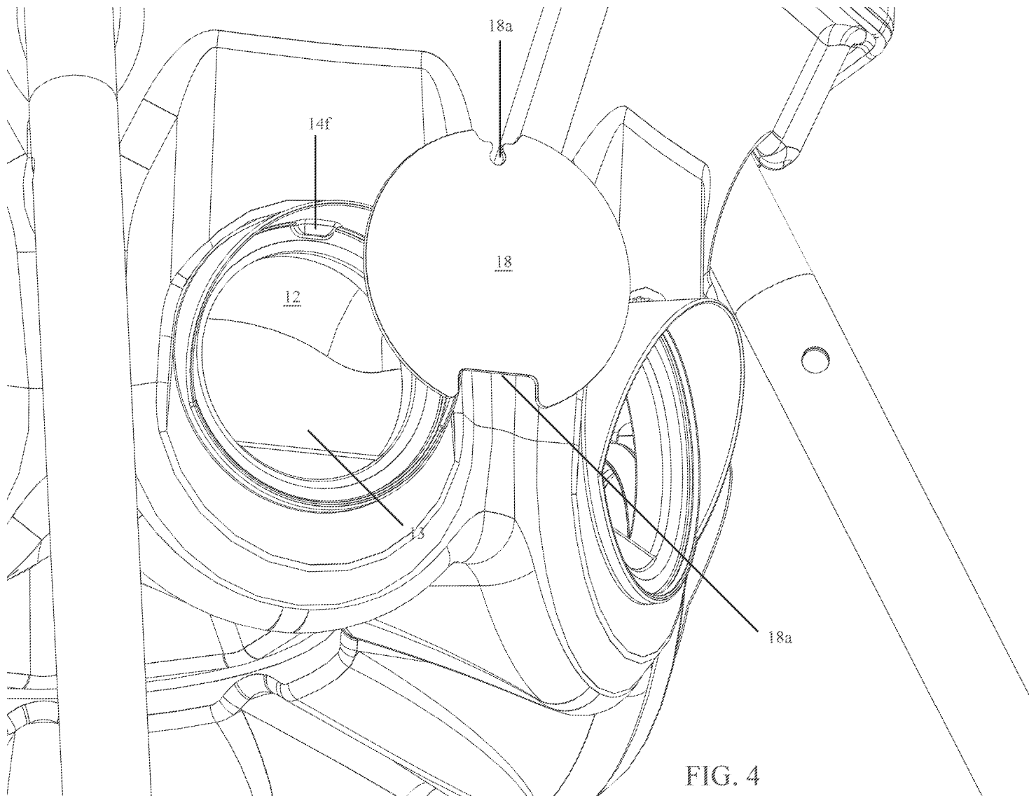

FIG. 4 shows another optional feature of the silo feeder 10—a cover 18 for a feed port 13. The cover 18 is a flattened structure that fits into the plug 14 such that it covers the opening 14d in the plug 14 that communicates with the interior cavity 12 of the silo feeder 10. Preferred embodiments of the cover 18 include one or more cutouts 18a in the cover 18 that accommodate and/or engage with a protrusion 14f that is formed by the notch 14e in the feed port plug 14. Additionally, there is an optional cutout 18a along a bottom of the plug cover 18 that lines up with the vertical wall 16 described above. This cutout 18a can make inserting and removing the plug easier in that it serves as a place where a user can grip the plug cover 18 with their finger(s). The plug 14 can feature an additional groove to accommodate the cover 18.

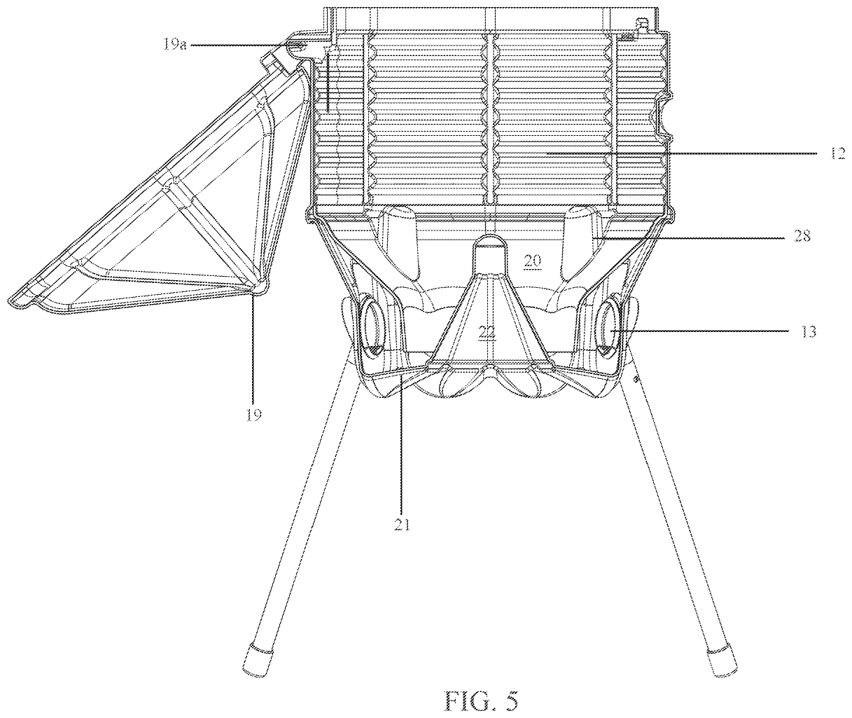

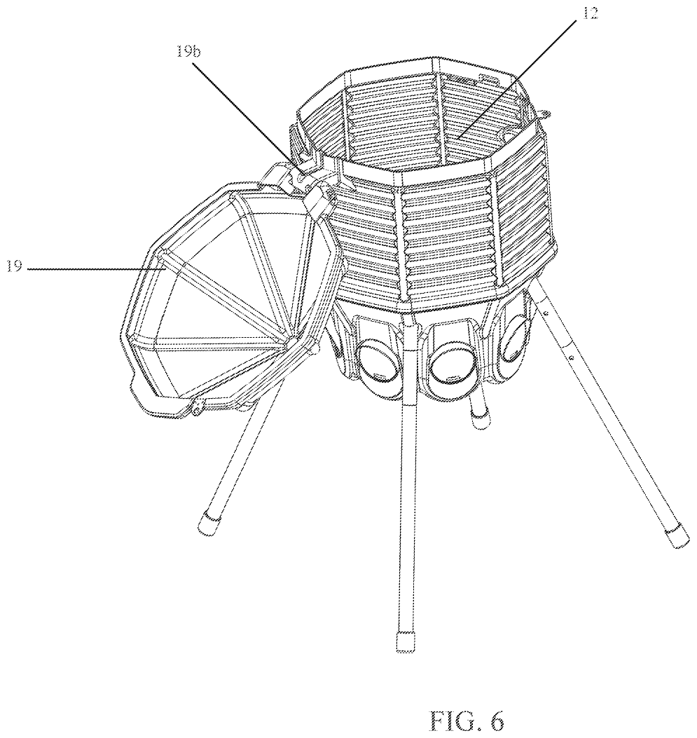

FIG. 5 shows a cross sectional view of a preferred embodiment of the silo feeder 10. FIG. 6 shows a top-down perspective view of the same feeder 10. Preferred embodiments of the feeder 10 include a hinged lid 19 that covers an opening of an interior cavity 12 of the body 11 of the feeder 10. FIG. 6 also shows an optional channel 19b in the hinge 19a of the lid 19 that accommodates an electrical cord (not shown) if one is needed for example to power an electric heater. The hinged lid 19 allows the user to access the interior of the feeder without completely removing the lid 19 and setting it on the ground. The groove 19a in the hinge 19 allows the user to open the feeder 10 without removing the both the lid 19 and any electrically powered device inserted into the feeder. In addition, near the hinge 19a, FIG. 6 shows optional clasps that can be added to the body 11 and the lid 19 so that a lock can be inserted through the clasp to lock the feeder 10.

The feeder 10 also includes an internal funnel 20 that is seated inside the interior cavity 12 of the feeder 10. The funnel 20 directs feed being poured into the interior cavity 12 toward a center of the floor 21 of the interior cavity 12. The floor 21 or bottom surface of the interior cavity 12 can be shaped to force feed to flow towards the feed ports 13 if desired. Preferred embodiments of the device include a floor 21 that includes a feed distribution cone 22 attached to or integrated into the floor 21. The shape of the funnel 20 directs feed entering the opening in the body 11 of the device on top of the feed distribution cone 22. As feed falls onto the feed distribution cone 22, it flows down the sides of the cone 22 toward the feed ports 13 of the feeder 10. The funnel 20 does not rest against the floor 21 of the interior cavity 12, but rather there is a space between the funnel and the floor 21 through which feed can pass. This configuration prevents feed from accumulating at the center of the floor 21 of the interior cavity 12 where animals are less likely to be able to reach it. This configuration also helps to preserve feed as little to no feed should be located in a place that cannot be reached by the animals.

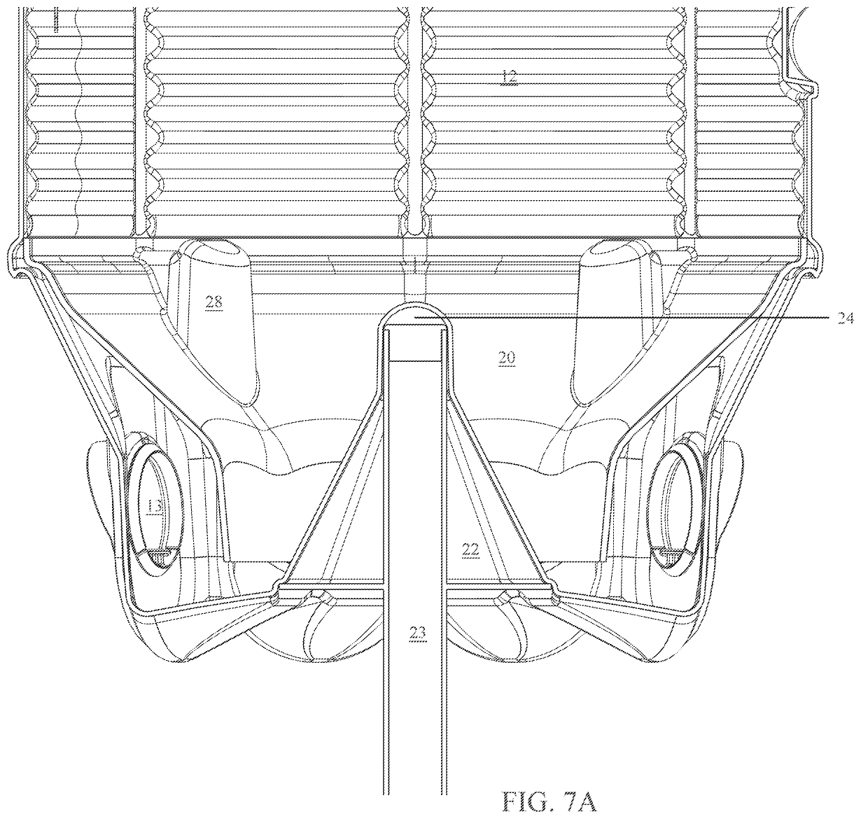

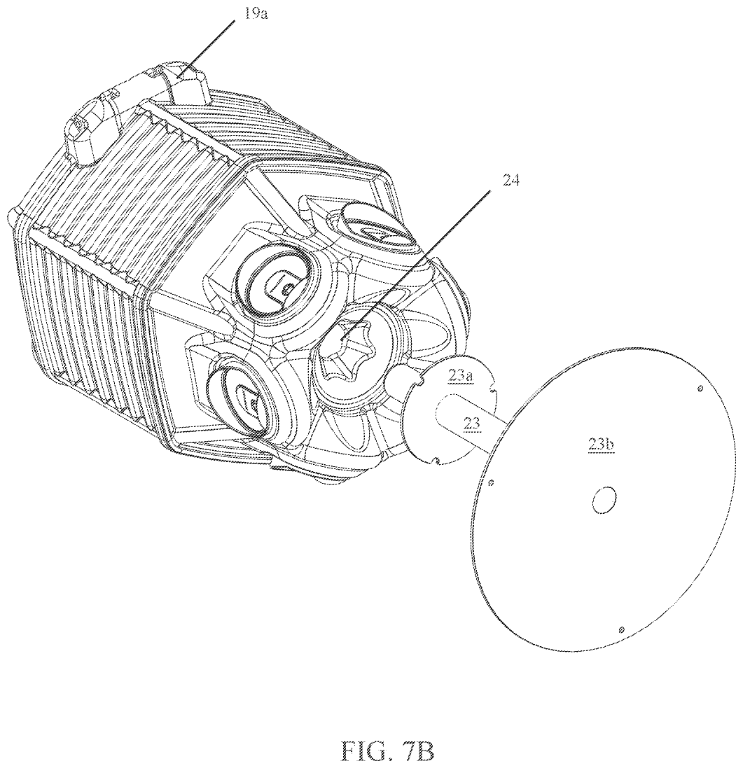

FIGS. 7A and 7B show an embodiment in which the silo feeder 10 is equipped with one or more optional legs or posts to hold the feeder 10 safely off of the ground. In this embodiment, there is a single post 23 that is inserted into a pocket 24 formed on the underside of the silo feeder 10, i.e. the side of the bottom floor 21 of the feeder 10 that is opposite the interior cavity 12. FIGS. 7A and 7B show the cone 22 extending upward into the interior cavity 12 of the silo feeder 10. The cone 22 forms the pocket 24 into which the post 23 inserts and holds the feeder 10 off the ground. In preferred embodiments and the inventors' anticipated best mode of the silo feeder 10, the post 23 is adjustable allowing the user to adjust the height of the silo feeder 10 by adjusting the height of the post 23. Other embodiments and the inventors' anticipated best mode feature a plate 23a fixed to the post 23 that prevents rodents from climbing up the post 23. Optionally, there is a platform 23b that can be fixed to the post 23 to stabilize the device 10.

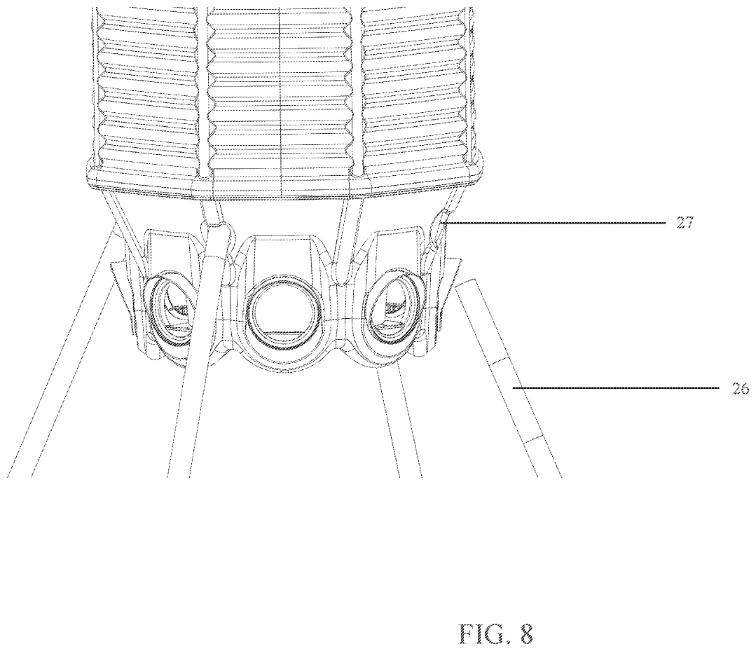

FIG. 8 shows an alternate embodiment of the silo feeder 10 that has a plurality of legs 26 inserted into molded sleeves 27 in the body 11 of the silo feeder 10. FIG. 8 shows one of these legs 26 in place and another leg 26 removed revealing the molded sleeve 27 into which the leg 26 inserts. In preferred embodiments and the inventors' anticipated best mode of the silo feeder 10, the legs 26 are adjustable allowing the user to adjust the height of the silo feeder 10 by adjusting the height of the legs 26.

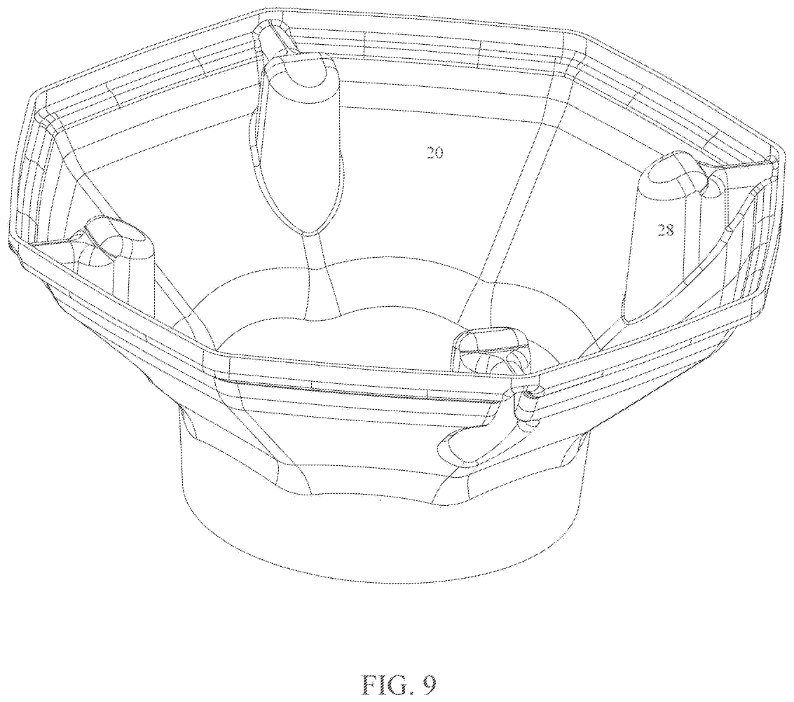

FIG. 9 shows a close up of the funnel 20 removed from the rest of the silo feeder 10. In the inventors' preferred embodiments and anticipated best mode, the funnel 20 features integrated molded female receptacles 28 that cover the molded sleeves 27 visible in FIG. 5 into which the legs 26 can be inserted. This configuration supports the legs 26 allowing them to support significantly more weight.

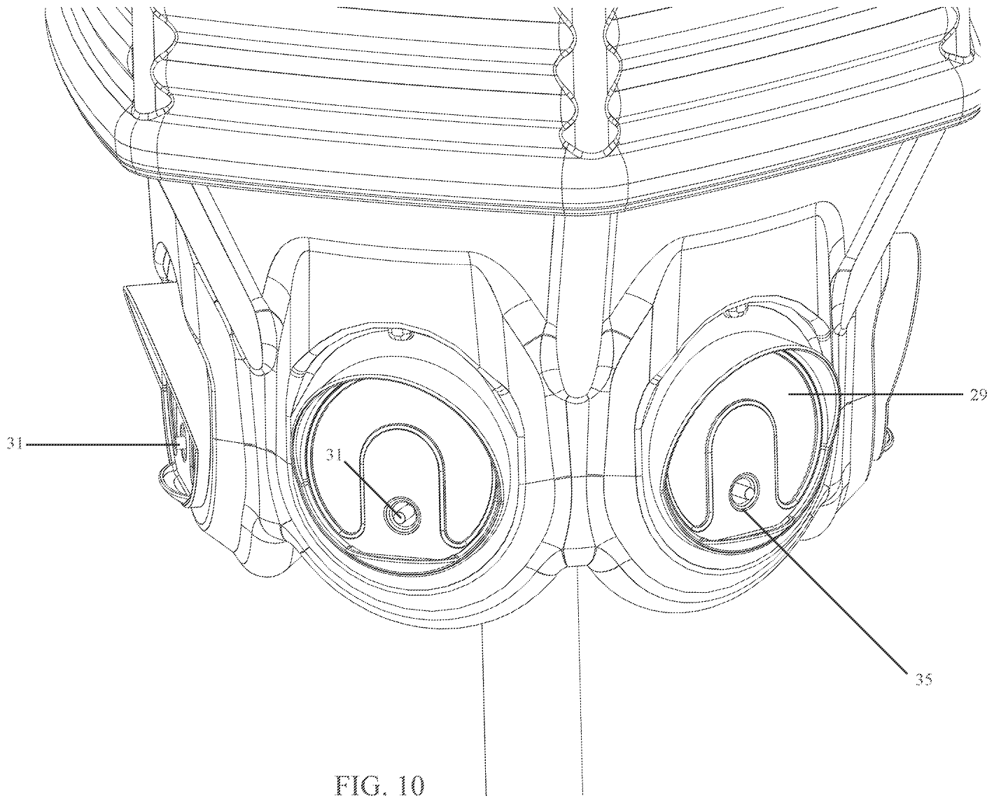

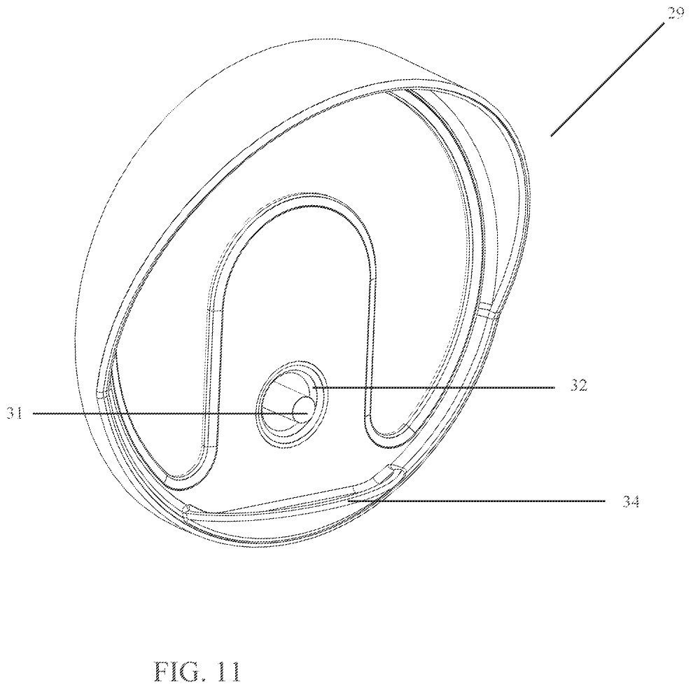

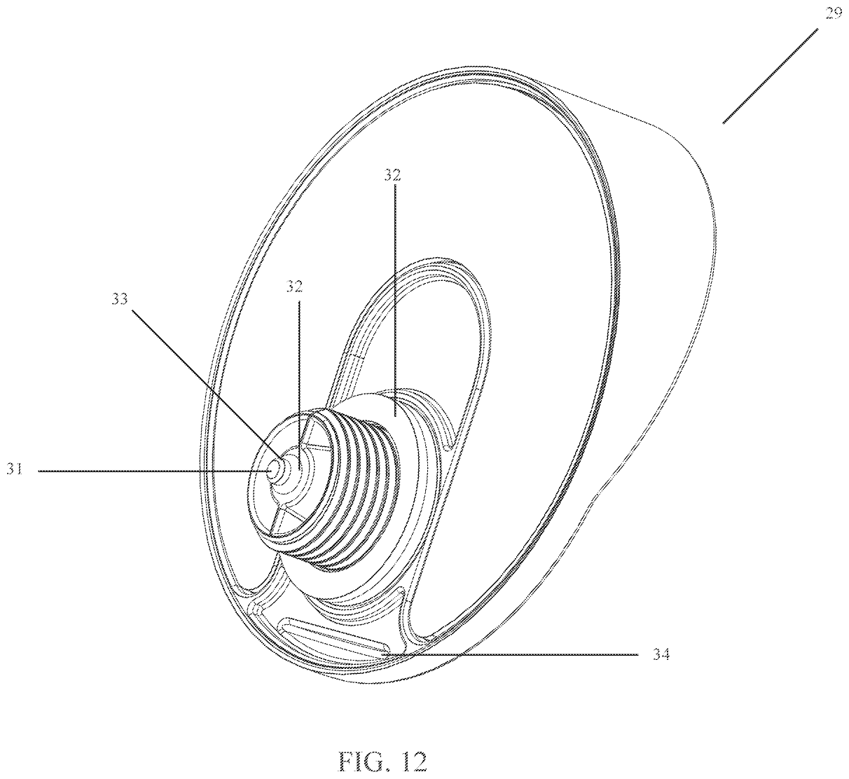

FIGS. 10, 11 and 12 show an alternate embodiment of the presently disclosed silo feeder 10 that is used to provide water to animals. In these embodiments, a water plug 29 is inserted into the feed port 13. The water plug 29 is substantially similar to the feed port plug 14 with the differences delineated below. The water plug 29 seals the feed port 13 and features a drinking valve or nipple 35. The drinking valve/nipple 35 may take a number of different configurations including a tube through which fluid can pass and one or more metal ball bearings inside that tube that function to seal an end of the tube shut. When an animal nudges or otherwise displaces the metal ball, water flows through the tube towards the animal. When the ball is not displaced, it settles back into place and blocks the opening again. Preferred embodiments and the inventors' anticipated best mode include a spring-activated pin 31 that is inserted into a hole in the water plug 29 that is flanked by O-rings 32 inside and outside of the water plug 29. When the animal pushes on the pin 31, the seal created by the pin and the O-rings 32 is broken allowing water to flow. Pushing on the pin 31 compresses a spring covering an exterior of the pin 31 against a structure or shelf 33 on the side of the water plug 29 facing the interior of the interior cavity 12 creating the force necessary to push the pin 31 back into place when the animal stops applying pressure to the portion of the pin 31 facing away from the device.

The plug 29 in these embodiments can include a drip tray 34 on the portion of the plug facing the interior cavity and/or the side facing away from the feeder 10. In addition, preferred embodiments of the water plug 29 feature O-rings 32 on the inside and the outside of the water plug 29 to “double-seal” the plug in place.

### INDUSTRIAL APPLICABILITY

In broad embodiment, the present invention is a feeding device for animals. While the device is disclosed as a bird feeder, it can be adapted to be used to dispense virtually any form of dry animal food by adjusting the height at which the device is positioned and/or increasing the size of the feed ports.

The advantages of the disclosed silo feeder include, without limitation, the ability to (1) protect the feed from damage caused by the elements, (2) keep the feeder off the ground, (3) keep the feeder out of reach of rodents and insects (4) prevent the birds from scratching feed out of the feeder and (5) prevents the birds from defecating in the feed.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

We claim:

1. A feeder comprising:
a body with an interior cavity and a tapered bottom wherein the tapered bottom has at least one feed port comprising an opening in the tapered bottom.

2. The feeder of claim 1 further comprising a lid with an upper surface that extends away from the body of the feeder at an angle of at least 30 degrees; and wherein the lid is positioned to cover an opening into the interior cavity.

3. The feeder of claim 1 further comprising a funnel positioned in the interior cavity.

4. The feeder of claim 1 further comprising a portion of a floor of the body of the feeder that is cone-shaped wherein the apex of the cone-shaped portion of the floor extends upward into the interior cavity.

5. The feeder of claim 4 wherein the at least one feed port is a horizontally oriented opening in the body of the feeder that faces outward and away from the body.

6. The feeder of claim 5 further comprising a plug shaped like a truncated cylinder, that is open at both ends and inserted into the at least one feed port.

7. The feeder of claim 6 further comprising a portion of a plug wall that extends further away from a base of the plug than another portion of the plug wall and forms a hood extending away from the base of the plug.

8. The feeder of claim 6 wherein the plug features a vertically oriented wall that covers a portion of an opening in the plug.

9. The feeder of claim 7 wherein the plug features a vertically oriented wall that covers a portion of an opening in the plug.

10. The feeder of claim 4 further comprising a pocket formed on the underside of the feeder by the cone-shaped floor wherein the pocket is shaped and sized to engage with a post inserted into the pocket.

11. The feeder of claim 3 further comprising:
a plurality of adjustable legs;
a plurality of molded female sleeves integrated into the body of the feeder;
wherein the plurality of adjustable legs insert into the plurality of molded sleeves integrated into the body of the feeder.

12. The feeder of claim 11 further comprising molded female receptacles integrated into the funnel and that are positioned to cover the plurality of molded sleeves when the funnel is inserted into the interior cavity.

13. The feeder of claim 6 wherein the plug also features a drinking valve.

14. A feed storage and distribution device comprising:
a body with an upper section, a lower section and an interior cavity;
at least one opening featured by the lower section of the body; wherein said opening leads into the interior cavity of the body;
wherein the upper section of the body features a drip edge located above the at least one opening.

15. The feed storage and distribution device of claim 14 further comprising a lid extending away from the body of the feeder at an angle of at least 30 degrees.

16. The feed storage and distribution device of claim 14 further comprising a plug with a drinking valve inserted into the at least one opening.

17. The feed storage and distribution device of claim 14 further comprising a funnel positioned inside the body of the device.

18. The feed storage and distribution device of claim 14 further comprising a portion of a floor of the body of the feeder that is cone-shaped wherein the apex of the cone-shaped portion of the floor extends upward into the interior cavity.

19. The feed storage and distribution device of claim 16 further comprising:
a portion of a plug wall that extends further away from the device than another portion of the plug wall and forms a hood extending away from the plug; and
a vertically oriented wall that covers a portion of an opening in the plug.

20. The feed storage and distribution device of claim 16 further comprising a drinking valve integrated into the plug.
